(19) United States
(12) Patent Application Publication
(10) Pub. No.: US 2021/0237577 A1
(43) Pub. Date: Aug. 5, 2021

(54) Method And System For Controlling Motor Vehicle Functions

(71) Applicant: Ford Global Technologies, LLC, Dearborn, MI (US)

(72) Inventors: Frederic Stefan, Aachen (DE); Christoph Arndt Dr Habil, Rhineland-Pfalz (DE); Uwe Gussen, Huertgenwald (DE); Frank Petri, Erftstadt (DE)

(73) Assignee: Ford Global Technologies, LLC, Dearborn, MI (US)

(21) Appl. No.: 17/159,612

(22) Filed: Jan. 27, 2021

(30) Foreign Application Priority Data
Jan. 31, 2020 (DE) 102020201235.0

(51) Int. Cl. B60K 37/06; B60K 35/00

(52) U.S. Cl. CPC B60K 37/06; B60K 35/00; B60K 2370/334; B60K 2370/11; B60K 2370/1531; B60K 2370/146

(57) ABSTRACT

Method and system for controlling motor vehicle functions with tracking of passenger positions and body orientations as well as movements, including of the limbs, and projection of a virtual user interface display onto any free surface within the vehicle cabin, wherein the user interface is used by a passenger to change vehicle functions, and with evaluation of passenger positions and body orientations as well as movements of the limbs in relation to the virtual user interface display to control the motor vehicle functions assigned to the virtual user interface display.

### CROSS-REFERENCE TO RELATED APPLICATIONS

This disclosure claims priority to and the benefit of DE application No. 102020201235.0, filed Jan. 31, 2020, which is hereby incorporated by reference herein in its entirety.

### BACKGROUND

The number of services and functions offered in vehicles is constantly increasing. Since every function and service must be controlled by the passengers of the vehicles, the number of dedicated user interfaces and human-machine interfaces (HMI) is also increasing. This poses new challenges in terms of ergonomics, costs, and integration. One trend is the implementation of intelligent surfaces and displays in the vehicle interior. However, their integration can be difficult due to the local heating they cause and the power supply they require.

Another problem is that the occupants of the vehicle are of different sizes, some are left-handed, others right-handed. In addition, passengers can change their orientation while driving: turn back, turn to the side, or look in a different direction.

What is more, with fully automatic vehicle occupants the freedom could arise to even change their place, to sit around a table, to rotate their seats.

In all these situations, well-known common fixed user interfaces are not directly accessible or not easily usable by all passengers.

It is well known that in motor vehicles the user can control a functionality of the vehicle by means of gestures (for example arms or hands). For this purpose, either a gesture is made in an empty air space without reference to an operating interface (HMI) or the approach of the hand is detected in front of an operating interface or display and its movement is tracked for contactless control of the corresponding dedicated function.

For example, DE 10 2013 201 746 A1 describes a gesture-based recognition system that receives desired command inputs from a vehicle occupant by recognizing and interpreting his gestures. An image of the inner section of the vehicle is taken and the image of the occupant is separated from the background in the captured image. The separated image is analyzed, and a gesture recognition processor interprets the vehicle occupant's gesture from the image. A command trigger reproduces the interpreted command along with a confirmation message for the occupant of the vehicle before triggering the command. When the occupant confirms, the command trigger triggers the interpreted command. In addition, an interference machine processor assesses the attention level of the occupant of the vehicle and transmits signals to a driving assistance system when the occupant of the vehicle is inattentive. The driving assistance system provides warning signals to the inattentive occupant of the vehicle when potential hazards are identified. In addition, on recognizing the driver a driver recognition module adjusts a set of personalization functions of the vehicle back to pre-saved settings.

WO 2017/084793 A1 describes a corresponding system in which a radar sensor is used in the vehicle cabin to track the movement of the body parts of the persons.

WO 201 8/031 51 6 A1 also describes radar-based gesture control monitoring in a motor vehicle.

### SUMMARY

On the other hand, the object of the present invention is to provide a method for controlling motor vehicle functions which allows easy handling and nevertheless achieves good results with reduced installation costs.

According to the invention, it has been recognized that if the controller is known to use gestures, but these always relate to a display, the operation is greatly simplified for the person. For this purpose, according to the invention each free surface or a free surface present in the vehicle cabin within the viewing and operating area of the respective passenger is used as a virtual display for the functionality in question, for which purpose this free surface is used as a projection surface for a virtual display and control surface.

In other words, the idea of the invention is to use a virtual display to represent an HMI in relation to the passenger's position, size and orientation by projection onto a suitable surface in such a way that the use of the HMI can be carried out immediately by the respective passenger in terms of his actual position and orientation, i.e. with a display device for the projection of a virtual user interface display onto any free surface within the vehicle cabin, where the user interface is used by a passenger to change the motor vehicle functions.

The interaction between the displayed HMI and the passenger is carried out by the use of body/hand tracking technology, i.e. a monitoring device for tracking passenger positions and body orientations as well as movements of the limbs by means of a group of sensors that are integrated into the vehicle.

The system knows the area in which it has projected the virtual display itself and therefore detects an interaction with the HMI display when, for example, the monitoring device detects that the passenger's hand (or other body part) is approaching or coming into contact with the HMI display. A virtual display can be associated with a specific functionality, which is then activated accordingly.

In other words, with an evaluation unit that relates data from the monitoring device regarding the passenger positions and body orientations as well as movements of the limbs to the virtual user interface display, control of the motor vehicle functions assigned to the virtual user interface display is made possible by replacing the determined change of the virtual user interface settings in the virtual user interface display by the specific movements of the passenger with a motor vehicle controller.

The advantages of the invention lie in the cost reduction and reduction of the integration effort since the system can even be realized with a plurality of projectors and cameras in the vehicle interior.

The virtual display and operating surface can then be operated in a known way by means of monitored gesture control.

In principle, all surfaces that are visible and accessible to the individual are considered as free surfaces. These can preferably be free as unused surfaces of the interior cladding, dashboard, seats, tables, even windows or existing displays, etc. It is even conceivable that body parts (legs, arms, etc.) of the passenger himself are used as a free surface. Holograms can also be used as displays. Then the free surface would be “the air space”.

According to the invention, the HMI or the virtual display displays contextual content with respect to different selectable parameters. These can be for example vehicle internal parameters, vehicle external parameters, driving situation, vehicle condition, etc.

The passenger can also access other HMI positions or menu items as intended.

In principle, the invention comprises five different functions or modules.

One function or module is the monitoring device for tracking passenger positions and body orientations as well as movements of the limbs by means of a group of sensors that is integrated into the vehicle. This means that a passenger body tracking system with a set of sensors is used.

The monitoring device can therefore detect and track passenger position, body orientation, dimensions and also passenger body/hand movements, etc. This function or module allows you the detection of an interaction between the passenger body or hand and a specific HMI display area.

A preferred implementation includes a state-of-the-art camera-based system or similar and image processing algorithms for recognizing people, body parts and their properties. An appropriate monitoring device can be integrated into a vehicle. For this purpose, it includes a vehicle condition information module, which provides the monitoring device with information about the vehicle condition (dynamics, acceleration, speed, vibration, incline, etc.). For example, information that is available through CAN data buses and is provided by ABS, steering, PCM, etc. control modules can be used. This information is used by the monitoring device to improve the accuracy of monitoring or tracking and to allow for predictive adjustment (for example passenger moves to the right when the vehicle is in a large turn).

In addition, there is the actual tracking sensor or group of sensors. A preferred implementation involves a camera-based sensor arrangement (i.e. it enables stereoscopic tracking/tracing) that is integrated at a specific position of the vehicle interior so that each passenger position can be monitored. The sensor arrangement can be connected to the on-board power supply and a vehicle data network.

The vehicle data network enables data communication in the vehicle (CAN, FlexRay, Ethernet, MOST, LIN). The vehicle's power supply allows power to be supplied to the vehicle's electronics and is connected to an electric power source.

The actual monitoring takes place in the tracking module. This is software that runs on at least one controller, computer hardware, an ECU of the vehicle or in the cloud. The systems and methods disclosed herein may be implemented on any processor coupled to memory. It can use state-of-the-art object recognition and tracking algorithms that have been improved for the automotive industry by using information about vehicle condition.

Another function or module is the user interface, which is used by a passenger to change vehicle functions.

This allows the selection, adjustment, or change, etc. of at least one or more parameters of the user interface (i.e. the user surface or interface that controls a characteristic of the vehicle). For example, the user interfaces could be: vehicle interior parameters (temperature, light, humidity, smell, sound, stress, fatigue, etc.), vehicle external parameters (weather, light, temperature, etc.), parameters of the vehicle's driving situation (traffic situation, localization, route, maneuvers, etc.), vehicle status parameters (activated features, failure modes, feature status, fuel status, speed, etc.).

Vehicle interior parameter sensors can also be used.

Corresponding internal parameter sensors can be identical to the tracking sensor(s) (cameras) or include dedicated sensors such as a seat sensor, an ultrasonic sensor, a lidar sensor, a temperature sensor, a light sensor, etc. External parameter sensors of the vehicle can also be used, such as LIDAR, camera, radar, ultrasound, V2X, cloud-based data or any sensor related to the operation of some vehicle functions.

Algorithms such as fuzzy mean clustering, classification, DNN, Kalman filters as a model-based approach, or vehicle navigation system data, GPS, vehicle speed, etc. can be considered as a method of determining the vehicle's driving situation.

Data from vehicle condition sensors can also be used. Data provided via the vehicle's data network (for example CAN, FlexRay, Ethernet, MOST, LIN) or via V2X communication or via some cloud data are suitable for this purpose.

In a further development, a content determination with respect to the passengers can be implemented in the display. For example, passengers sitting in the driver's seat (if available) may receive different content than those sitting in the back rows. Children can be offered different content than adults.

In a parameter extraction module, the described parameters are extracted based on the data of the sensor groups. Current algorithms that currently outperform humans in the field of image recognition or analysis can be used here to extract the data. For example, state-of-the-art image processing and computer vision algorithms can be used to detect passengers in the vehicle or to extract temperature values from the internal sensor. These data then flow into the user interface display or display selection device (see below).

Based on the above parameters, a content determination module determines at least one content item to be displayed for at least one passenger on the virtual display. The aim is to offer the passenger a reduced interaction opportunity and not to overload them with interfaces that may not be used in the current time window. This module can be based on a model such as DNN (deep neural network), decision tree, state machine, or simply a set of predefined rules, wherein the input options are determined by the above parameters and the output consists of a collection of one or more HMI elements.

For example, under the following conditions:
Vehicle interior parameter: temperature is 24° C.
Vehicle external parameter: temperature is 30° C.
Vehicle drive situation parameter: motorway travel
Vehicle condition parameters: vehicle speed is 120 km/h, no assistance systems activated.

The following are presented as content for all passengers on the virtual display as functionality
Setting air conditioning temperature
Setting blower intensity
Connectivity (Internet access), own displays of information functions
Seat position, seat heating.

However, other functions are offered only to the driver:
Activate ACC
Setting the ACC distance
Controlling the audio system
Navigation.

This ensures that there is always an interface path that allows the user to access all the functions available in the vehicle.

Another function or module is the display device itself, which includes the projection of the user interface as a virtual display onto any free surface within the vehicle cabin. Various display technology or devices implemented in the vehicle interior can be used, such as OLED, surface-mounted displays (such as intelligent surfaces of the interior cladding, which are simultaneously designed as displays), projectors, etc. Preferably, one or more projectors are used.

For example, intelligent surface areas can cover large areas of the vehicle interior, such as dashboard, seat, armrest, window, windshield, roof, floor, which can therefore be considered as free surfaces.

In a further implementation, mobile devices (mobile phones, tablets, etc.) of the passengers themselves are included when they are connected to the vehicle network.

Furthermore, as a preferred embodiment, a projector may be installed in the vehicle. The projector can display images of the virtual display on a dashboard, seat, armrest, windows, roof, floor, passenger, etc. In a further development, this may also include holographic projection.

The display technology is connected to the vehicle's electrical supply network and is connected to the rest of the system via one of the vehicle data networks. This can be MOST, Ethernet, WiFi, CAN, FlexRay, etc. The data transferred to the display technology can be images or simply image configuration information that allows the display technology to reconstruct the image for virtual display, i.e. the system can include a dedicated GPU that can access predefined interface elements. In this case, the data network transmits only the identifiers of the required elements and possibly their layout, and the GPU, which can be hosted by the projector, carries out the rendering.

Another subunit can also be implemented in the display device, namely a display selection device that determines the free surface to be used for display based on the data from the monitoring device. Some criteria for determining the location are, for example, passenger position, passenger dimension, arm and/or hand posture, ride perspective, or field of view. In addition, the decision incorporates the known spatial conditions and equipment of the vehicle, where, for example, there is unused space in the immediate vicinity of the passenger in question.

Another function or module is an evaluation unit, which relates data from the monitoring device about passenger positions and body orientations as well as movements of the limbs to the virtual user interface display in order to enable control of the motor vehicle functions assigned to the virtual user interface display by replacing the determined change of the virtual user interface settings in the virtual user interface display by the determined movements of the passenger with a motor vehicle controller. This performs the actual task of merging the data from the monitoring and the relation to the virtual display and generation of the change commands for the respective vehicle function.

The display selection device can incorporate data from various criteria such as passenger position, passenger dimensions, passenger arms/pointer position, passenger eyes/field of view position.

For example, in the module for determining the display area based on the information of the monitoring device and using state-of-the-art image processing/computer vision algorithms, the system performs the following processing steps, for example:

Determining the current position of the passenger and the fields of view (viewing direction);

Determining handedness, for example whether the passenger is left-handed or right-handed?

Identifying the nearest display area in relation to the passenger's position and field of view.

Setting the previously identified area for the left/right hand of the passenger;

If the nearest display area may not be close enough to the passenger's field of view, selecting a standard display area and sending a special notice (for example flickering warning, symbol, arrow, arrow) at a nearest display area within the driver's field of view of the driver to attract the driver's attention and direct it to the display containing the display information. In addition, an acoustic prompt can be used as an attention-grabber for the passenger.

The module can be run as stand-alone computer hardware or as software in an ECU of the vehicle.

It is understood that the computer hardware or ECU is equipped with an appropriate memory and CPU as well as programming to perform the functions in question.

The system can contain a database or memory in which vehicle functions are assigned to respective HMI interfaces. For example, the virtual display “A/C On” could be assigned to a CAN bus message to turn on the air conditioning system.

The system may also include other HMI interfaces, which in turn are connected to some HMI interfaces. For example, if an HMI element is selected, the system may open/create another HMI element. The further HMI element would then preferably depend on the situation, which includes external parameters (for example driving situation) and internal parameters (for example temperature).

The system can be set up or programmed to repeat the following sequence of actions either at regular intervals or either after an HMI interaction with a passenger or after a change of a parameter (for example, the HMI can offer “Start Traffic Jam Assist” for a change of driving situation from free travel to traffic jam):
Determining an HMI display area with the display selection device;
The system determines the position of the selected HMI display area;
The HMI to be displayed will be selected or determined based on the monitoring unit and the vehicle functions and the incorporated parameters.
Display of the virtual display with the display device.

Once the virtual user interface is displayed, the system continuously monitors the gesture interaction between the passenger and the virtual display area.

The system is designed in such a way that precise body tracking of the passenger is carried out by the monitoring unit. Thus, the system can monitor the vehicle areas in which the passenger's hand movements take place. If the motion area matches an HMI display area, an interaction is detected, and the system performs the associated functional process.

To facilitate monitoring of the interaction between the passenger and the virtual user interface (HMI), the system can carry out mapping of the vehicle with a system of 3D coordinates. When determining the display areas, the system can store these display areas in memory. When the system then performs the passenger body tracking, it can check the 3D coordinates of certain gestures/body movements (for example fingers of the hand pointing at something) and compare these 3D coordinates with those of the HMI display area.

The virtual user interface (HMI) can be personalized specifically by individuals according to their preferences. Only the driver has access to all vehicle functions, while passengers can only adjust selected specific functions, such as comfort related (heating, seat heating,), connectivity (BT connection, WLAN, Access-Point), or perform a personalized compilation of the permitted user interface functions.

For example, the virtual user interface (HMI) contains a controller (ECU) that determines the person's position (using the corresponding sensors), calculates an appropriate (projection) surface for the display from this, calculates and generates the projection on this surface, and monitors, detects and evaluates an interaction of the passenger with this display.

In a further development, the system can be designed to implement the virtual display or user interface in the passenger's smart devices (mobile device, smart glasses/smart tablet).

The invention has the following advantages:
The passengers are not overloaded due to optimally defined interface content.
The virtual user interface display is displayed specifically to the passengers, taking into account height, orientation, and actual position.
The system can be implemented identically in different vehicle models because no platform-specific integration is required.
The system is universal and generic, the user interface adaptation to new functionalities is easy to implement. Each user interface can be represented by the system.
Cost reduction by replacing all user interface devices with virtual elements;

### BRIEF DESCRIPTION OF THE DRAWINGS

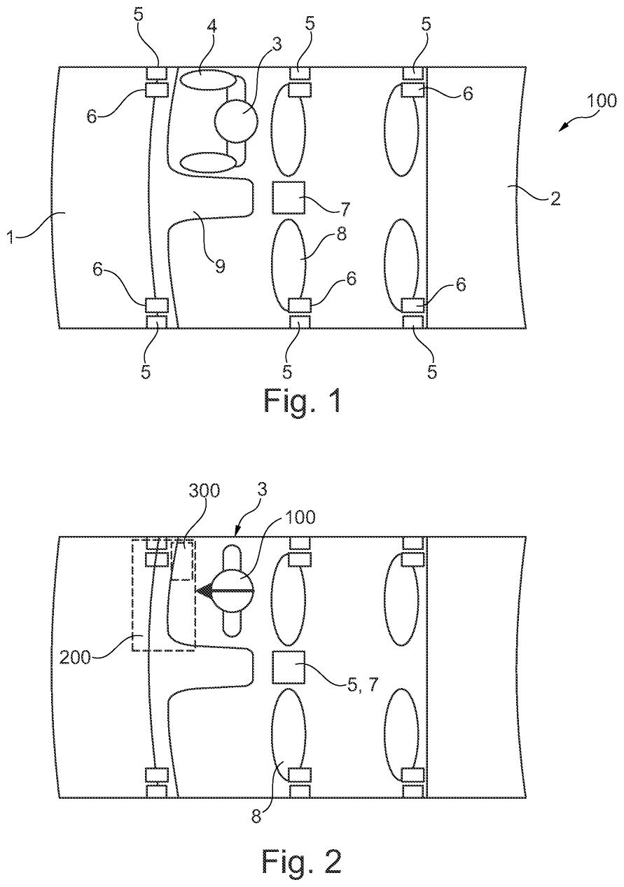

Further details of the invention can be obtained from the following description of embodiments based on the drawing; in which FIGS. 1 to 4 each show a schematic view of the interior of a car in different states.

### DETAILED DESCRIPTION

In the Figures, a car marked as a whole with 100 or its interior is shown in a bird's-eye view.

The number 1 denotes the front and 2 denotes the rear of the vehicle. A passenger 3 is sitting on the passenger side and is characterized by his position and body orientation. The number 4 denotes his right arm.

A sensor 5 which is arranged in the area of the dashboard in front of the passenger 3 towards the outside of the vehicle allows tracking of the movements of the passenger 3 and in particular his right arm 4. Analog sensors are distributed across the passenger compartment.

A projector 6 which is also arranged there carries out the virtual user interface display. In the present case, it is a conventional projector. However, laser projectors, hologram projectors or 3-D projectors could also be used.

Another central unit 7, which is arranged approximately in the middle of the vehicle, contains at least one further tracking sensor for monitoring body movements as well as an additional central projector. Better spatial coverage of the vehicle cabin is thus ensured.

The vehicle seats are denoted by 8, wherein it is a common configuration with two vehicle seats in the front row and two vehicle seats in the back row.

In the present case the center console 9, which is shown between the driver (not shown) and the passenger 3 (shown), can be used as a free surface for displaying the virtual user interface. In principle, however, other surfaces are possible, such as the entire dashboard, the doors, the windows, the seats, etc., and even the body surfaces of the passengers.

For the sake of simplicity, it is assumed below that the vehicle is only occupied by the passenger 3 and that the following three functionalities are active in the vehicle: air conditioning, autopilot, radio of the entertainment system.

Based on the status of the activated functions, the system 100 creates a contextual list of user interface entries that make sense for the user (the passenger 3): increasing the temperature of the air conditioner, changing the route to the destination, or decreasing the volume of the radio.

The system is designed with a predefined catalog or database, in which an association is stored between the respective function change command and the virtual user interface display.

The system 100 first uses the monitoring device and tracking algorithms to determine the position and orientation of the passenger 3 based on the sensor data from the sensors 5 and 7.

Based on this information, the system determines an area 200 in which the virtual user interface display 300 with its entries can be well represented (see FIG. 2).

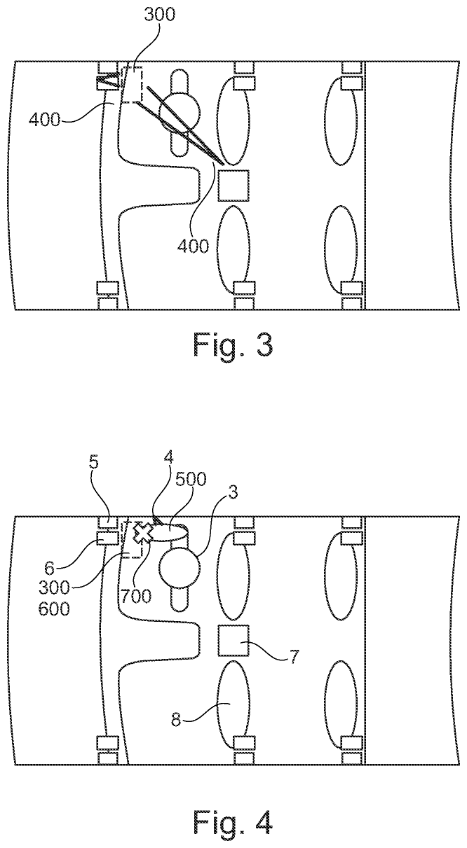

The system then activates the projectors 6 and 7 to actually project the virtual user interface display 300 into the area 200, which is indicated in FIG. 3 by the rays 400.

The system then monitors the passenger for possible movements that could interact with the virtual user interface display by means of the sensors 5 and 7 and using a second body tracking algorithm that specializes in tracking the passenger's right arm 4.

If the system detects a movement of the passenger's right hand 3 (step 500) that represents an interaction with the virtual user interface display 300 and assigns an increase in the air conditioning temperature (step 600), a corresponding command is triggered. The interaction is referred to with 700 in FIG. 3 and is detected by using coordinates of the virtual display areas and the coordinates of the passenger's right hand in the evaluation unit, which uses an image recognition algorithm to do so.

The method then starts again or additional functionalities can be carried out. A change in the corresponding functionality is only performed if the corresponding trigger is actually detected. In addition to the corresponding gesture detected by the corresponding monitoring sensors 5 and 7, the triggers can also be voice commands, exceptional situations or their messages from the vehicle system (for example a drop in a tire pressure), emergencies or critical driving situations, as well as the operation of classic operating elements such as buttons or controllers, which are integrated in the dashboard or vehicle, or corresponding mobile devices that serve as triggers with a functionality via an app.

It is understood that the system can be activated and implemented separately for each passenger. It is possible that an initial activation is carried out when boarding or driving off using conventional methods in order to reduce conflicts or misuse.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments.

1. A method for controlling motor vehicle functions, comprising:
tracking of a position, body orientation, and movement of a passenger; and
projecting a virtual user interface display onto a free surface within a vehicle cabin,
wherein the virtual user interface is used by the passenger to change vehicle functions, and
wherein the vehicle functions assigned to the virtual user interface display is based on evaluation of the position, body orientation, and movement of the passenger in relation to the virtual user interface display.

2. The method according to claim 1, wherein projection of the virtual user interface display is dependent on the position of the passenger.

3. The method according to claim 1, wherein projection of the virtual user interface display is dependent on a vehicle condition.

4. The method according to claim 1, wherein projection of the virtual user interface display is dependent on a driving situation.

5. The method according to claim 2, wherein detection of a body of the passenger is carried out with regard to orientation, dimension, and/or position.

6. The method according to claim 1, wherein detection of movement of a hand of the passenger is carried out with regard to orientation, position, and/or speed of movement.

7. The method according to claim 6, wherein an interaction with the virtual user interface display is detected from a detected movement of the hand.

8. A system for controlling motor vehicle functions, comprising:
a monitoring device comprising a group of sensors for tracking a position, body orientation, and movement of a passenger;
a display device for the projection of a virtual user interface display onto a free surface within a vehicle cabin, wherein the virtual user interface is used by the passenger to change vehicle functions; and
an evaluation unit that sets data from the monitoring device relating to the position, body orientation, and movement of the passenger in relation to the virtual user interface display in order to enable control of the motor vehicle functions assigned to the virtual user interface display by replacing a determined change in the virtual user interface settings in the virtual user interface display by a determined movement of the passenger with a motor vehicle controller.

9. A virtual user interface displayable on a surface in a vehicle, comprising
a projection that provides a display for a passenger, wherein a camera arrangement that monitors the passenger in the vehicle and which, together with a controller, determines a suitable location for the display from an orientation and movement of the passenger are monitors and tracks the passenger in order to be interpreted as an interaction with the display as a user interface in subsequent processing.

10. The virtual user interface display according to claim 9, wherein various types of information are provided, selected from the group including internal parameters of the vehicle cabin, external parameters, parameters of the driving situation of the vehicle, and parameters of the vehicle condition.

11. The virtual user interface display according to claim 9, wherein it can be used together with other displays brought into the vehicle by passengers, in particular those present in mobile devices or tablets or other smart devices etc.

12. The virtual user interface display according to claim 9, wherein the optimized position of the projection or display is determined on the basis of the position and/or dimensions of the passenger and/or the position of the arm and/or the hand and position of the passenger's field of view in order to ensure the most comfortable use.
